(19) United States
(12) Patent Application Publication
(10) Pub. No.: US 2008/0195377 A1
(43) Pub. Date: Aug. 14, 2008

(54) METHOD, DEVICE, AND PROGRAM PRODUCT FOR VERIFYING TRANSLATION IN RESOURCE FILE

(75) Inventors: Naotaka Kato, Fujisawa-shi (JP); Kazunori Matsushita, Yamato-shi (JP)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/962,460

(22) Filed: Dec. 21, 2007

(30) Foreign Application Priority Data
Feb. 9, 2007 (JP) 2007-30870

(51) Int. Cl. G06F 17/28

(52) U.S. Cl. 704/8

(57) ABSTRACT

The present invention provides a method for allowing users to easily know changes in PII character strings in a context at the time of execution of software. One aspect is a method for translation verification including the acts of: creating four text files, each corresponding to old and new versions in a first language and a second language, from a set of old and new versions of PII files in the first language and old and new versions of PII files in the second language; creating an intermediate file, which uses a key name contained in the new version of text file in the first language and a file name as retrieval keys, from the four text files; and creating a PII file for translation verification in the second language with reference to the intermediate file, is provided. Furthermore, a method, for displaying a translated character string on a GUI screen on the basis of a change attribute ID, including an act of attaching, to the intermediate file, a change attribute ID representing a type of change in the text files obtained by comparing old and new versions of text files in the first language and the second language, is provided.

### TECHNICAL FIELD

The present invention relates to methods, devices, and program products for verifying translation in software resource files. More specifically, the present invention relates to a method, a device, and a program for performing translation verification of character strings contained in PII files, namely, one kind of resource files.

### BACKGROUND

Hitherto, many systems that automate translation of software are known. For example, Japanese Unexamined Patent Application Publication No. 2000-207399 [Patent Document 1] discloses an automating system for allowing words newly added at the time of version upgrade of package software to be automatically replaced or migrated. In addition, Japanese Unexamined Patent Application Publication No. 10-91418 [Patent Document 2] discloses a method for realizing multilingual software that registers terminology in a native language to databases provided for each industry and language classification, further registers terminology in other languages in association with the terminology in the native language, identifies an execution language on the basis of language type information at the time of execution of software, and acquires this terminology.

However, such systems and methods are tools for translation or tools for developing software in a multilingual environment, but are not tools to make verification of created translation more efficient at the time of the translation verification test (hereinafter, abbreviated as TVT). Translation of character strings used in user interfaces and messages, which are called PII (program integrated information) character strings, is necessary to make software compatible with multiple languages. However, few systems for efficiently verifying the translation of PII character strings are known.

PII character strings are character strings that appear on GUIs (graphical user interfaces) of programs, such as, for example, a task bar and a menu bar. Programs communicate with users through PII character strings. Generally, programs requiring internationalization do not include these PII character strings therein. Instead, keys (IDs for identifying character strings) are embedded in the programs, and character strings corresponding to the keys are prepared in an outside resource file. Then, character strings referred to by the keys are displayed on a GUI. This resource file is called a PII text resource file (abbreviated as a PII file). In this way, multilingual software supports various languages by switching the PII files for each country. A PII file is also a kind of resource file (also called a property file in the Java® environment) that defines resources used by software.

Generally, in a PII file, each piece of data is constituted by a key and a character string corresponding to the key. In the following, one line in an English PII file is shown as an example:

keyProfileLocation=Copy profile to

Here, “keyProfileLocation” is a key, while “Copy profile to” is a character string corresponding to the key. Such a data set continues for lines, and constitutes a PII file. This line is denoted in a Japanese PII file as follows:

keyProfileLocation=Purofairu no kopi saki

Since translation of PII character strings is performed in a PII file, translators perform translation work while not knowing a context in which the PII character strings are used or actual meanings of the PII character strings. Accordingly, in translation of PII character strings, it is necessary to operate actual test target software and to verify translation of character strings output by software on a GUI screen in a context that the character strings are used. In addition, in existing translation verification, whether PII character strings are translation-verified ones that exist in old edition (old version), are newly added ones, or are modified ones is not distinguishable.

One of important things about translation of PII character strings is that translating an entirely new PII file, such as version 1.0 or release 1.0, is extremely rare in the translation of PII character strings. An actual situation is that such a case exists less than once out of ten times. Even in version 1.0, existing programs are often used in combination. For this reason, a probability of the first translation is extremely low. In many cases, translation of PII character strings is performed in association with version upgrade or release update.

When translation is not entirely new (which is true in most cases), it is difficult for testers (test executors) who verify PII character strings to tell whether an output PII character string is a character string translated the last time or a character string newly translated. Thus, since the testers verify translation of both character strings having been verified in the previous version or release and character strings not verified yet with equal care, efficiency of translation verification is extremely low. Solutions for efficient verification of translation associated with such a version change do not exist hitherto. For example, a change in new and old versions of Japanese and English character strings can be confirmed by checking the change in each of PII character strings, however which is not practical.

In addition, even if the testers know that translation is improper Japanese, it takes some efforts in referring to files or the like in order to refer to the original English words, thus English words cannot be referred to easily. Additionally, if translation is improper but is natural Japanese, the testers cannot so much as modify the mistranslation. A known measure for this is a method for separately providing an English testing environment, and performing testing operations similar to those in Japanese, and comparing the result in the English testing environment with the result of the Japanese testing environment one by one. However, in this method, it takes a time to shift eyes for each of the PII character strings, which is extremely inefficient.

If one tenth of the whole PII is added or updated and testers can know which PII character strings are the one tenth of the whole PII, efficiency of translation verification improves in a unit of tenfold since translation of the others has already verified. When only new and old versions of Japanese have changed despite that there is no change in new and old versions of English, great attention has to be paid because improper translation may possibly given using a translation tool, represented by Translation Manager® by IBM® Corporation. Generally, it is impossible to notice such a change while performing a translation verification test on a GUI. Accordingly, if types of change in translation can be known on a GUI and PII character strings and the original words for them can be simultaneously referred to, which leads to not only improvement of efficiency of the translation verification test but also improvement of translation quality.

### SUMMARY

Embodiments of the present invention allow testers to efficiently discover mistranslations of PII character strings by providing a method for allowing testers to easily know changes in PII character strings in a context on a GUI, a program realizing the same, and a device having the program installed therein.

In a first aspect of the present invention, a method for verifying a character string translated from a first language (a source language) into a second language (a target language) in a resource file of verification target multilingual software using a tool program for verification is provided. Four text files, each corresponding to old and new versions in the first language and in the second language, are created by the tool program from a set of old and new versions of PII files in the first language and old and new versions of PII files in the second language resulting from version upgrade of the verification target software. Then, a character string to be translated, a key name serving as an identifier of the character string, a directory name and a file name of the PII file in the first language that contains the character string are extracted from each of the four text file. Furthermore, an intermediate file containing a plurality of records in which the extracted key name, the directory name, and the file name are attached to the character string as retrieval keys is created, and a PII file for translation verification in the second language is created from each record included in the intermediate file. Since changes in translation resulting from version upgrade are known or become clear at the time of execution of the software by using this created PII file for translation verification (a PII test file), the method is effective for efficient translation verification.

In a second aspect of the present invention, the method may further include the acts of the tool program comparing old and new versions of character strings in the first language and old and new versions of character strings in the second language included in each record of the intermediate file with reference to the retrieval keys, the tool program extracting the new version of the character string in the second language as a character string for displaying if the old and new versions of the character strings in the first language are the same and the old and new versions of the character strings in the second language are the same, and the tool program extracting the new version of the character string in the first language and the new version of the character string in the second language as the character strings for displaying otherwise.

In a third aspect of the present invention, the method may further include the acts of the tool program comparing old and new versions of character strings in the first language and old and new versions of character strings in the second language included in each record of the intermediate file with reference to the retrieval keys, and the tool program attaching a change attribute ID, representing a type of change in the character strings obtained based on the comparison result, to each record of the intermediate file.

These and other aspects of the present invention can be also provided as a computer program for allowing a computer to execute each act of the above-described methods, or an information processing device that implements the computer program.

### BRIEF DESCRIPTION OF THE DRAWINGS

FIG. 1 is a diagram showing an overview of processing of a verification tool program according to one embodiment of the present invention.

FIG. 2 is a table of types of new and old English and Japanese change attribute ID.

FIG. 3 is a table of change types of new and old versions used as a basis of FIG. 2.

FIG. 4 is a diagram showing a flow of creating a new version of Japanese PII file for translation verification.

FIG. 5 is a chart showing alternative processing for a verification tool program to display translated character strings on a GUI screen.

FIG. 6 is a flowchart showing details of acts S1 and S2.

FIG. 7 is a flowchart showing details of acts S3 and S4.

FIG. 8 is a diagram showing a capture image when a CATIA PII file is replaced by a PII file created by a verification tool program.

FIG. 9 is an enlarged diagram of a pop-up menu of FIG. 8.

FIG. 10 is a diagram showing a capture image displaying change attribute IDs when a CATIA PII file is replaced by a PII file created by a verification tool program.

FIG. 11 is a diagram showing functional blocks of a PII verifying device 10 according to an embodiment of the present invention.

### REFERENCE NUMERALS

10: PII verifying device
11: control unit
12: PII file input unit
13: storage unit
14: display unit
15: operation unit
16: intermediate file
17: PII test file
18: change type table
19: new verification target software
21: old English PII file
22: old Japanese PII file
23: new English PII file
24: new Japanese PII file
31: GUI screen
32: user
41: old GUI
42: old application
43: old PII file
44: new GUI
45, 48: new application
46: new PII file
47: test GUI
49: PII test file
81, 82, 83, 84: Japanese and English character strings displayed in pair

### DETAILED DISCLOSURE

Here, as described later, the change attribute ID (also referred to as a change ID) indicates types (categories) of changes in character strings contained in the old and new versions of PII files in the first language (the source language) and the old and new versions of PII files in the second language (the target language) resulting from version upgrade (including release update) of software. Furthermore, in the present invention, users (TVT testers or developers of verification target software) are prompted to specify this change attribute ID. The translated character string in the target language and the pre-translation character string in the source language are extracted from each record of the intermediate file having the specified change attribute ID, and are concatenated by a separator. These concatenated character strings are then displayed on a GUI screen displayed at the time of execution of the software. Here, the change attribute ID may be displayed together with the character strings, or displaying of the change attribute ID may be omitted. In addition, the change attribute ID is not necessarily specified by users. Only changed character strings may be displayed after comparing the new and old versions of character strings. The new version of PII file in the target language may be replaced by the PII file for translation verification created according to the present invention, and the changed character strings may be displayed on a GUI screen at the time of execution of verification target software (new version in the target language).

Additionally, the above-described key includes a directory name and file name of the PII file, and a key name to be used as retrieval keys. However, the directory name may be included in the file name. In the intermediate file, one line of text constitutes one record. In each record, the directory name, the file name, the key name, the character strings, and the change attribute ID may be separated using a predetermined separator, like a CSV (comma separated value) file. In embodiments described later, “=” is used as a separator because using “=” as a separator is more convenient than using other separators since data is often represented in a format of “key=character string” in PII files.

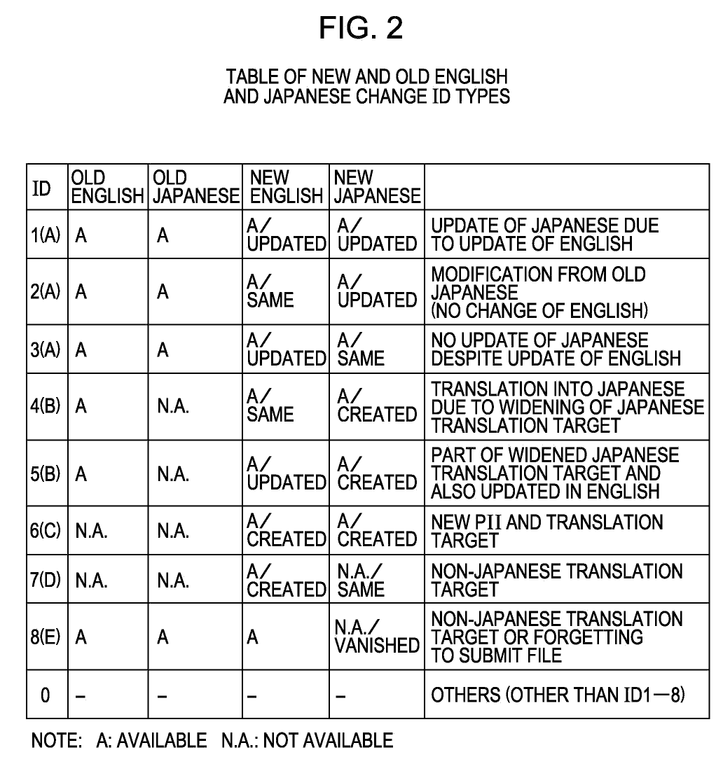

The change attribute ID is categorized as shown in a type table (FIG. 2), which will be described later. The change attribute ID is classified on the basis of combinations that whether each of the old version of files in the first or source language and in the second or target language is “available” or “not available”, and that whether each of the new version of files in the first language and the second language is “available and the same” (the new and old versions are the same), “available and updated” (the new version is updated), “available and created” (the new version is newly created), “not available and the same” (neither the new version nor the old version exists), or “not available and vanished” (the new version is vanished). Other than those, the types of the change attribute ID may include “others” (indicating that no changes exist in new and old versions, or that the change is meaningless).

In the description given below, it is assumed that the first language (the source language) is English, whereas the second language (the target language) is Japanese. Advantages of the present invention include the following.

Firstly, changes in new and old versions of Japanese and English PII character strings can be displayed on a GUI. In the translation verification test (TVT) of PII character strings of version-upgraded or release-updated software, various changes in the PII character strings occur in English, Japanese, or combination thereof between the new and old versions. The present invention allows users to identify these changes or that no changes have occurred at a glance on a GUI. By configuring in this manner, in the translation verification at the time of version upgrade, users can perform translation verification mainly on those newly translated or those whose translation has changed, but not those whose translation has been already verified in the old edition (the old version). Since the present invention allows users to concentratedly verify changed parts, working efficiency dramatically improves. In addition, oversights of changed parts are eliminated, thus quality also dramatically improves. If one tenth of the whole PII character strings is added or changed, efficiency improves tenfold.

Secondly, only for character strings having been changed, not only Japanese but also English (the original) are displayed on a GUI. For those not having been changed, only Japanese is displayed. The character strings to be displayed are the new versions in either language. Since users can see both English (the original) and Japanese character strings on a GUI by configuring in this way, the users can immediately determine correct or incorrect translation. Accordingly, verification efficiency dramatically improves.

Thirdly, according to aspects of the present invention, since users can easily know changes in PII character strings during operations on a GUI, efficiency of the translation verification test dramatically improves. In addition, since users can focus on parts where there are changes in translation between new version and old version, translation quality improves.

### FIRST EMBODIMENT

In the following, a verification tool program for verifying PII files will be described as one embodiment of the present invention with reference to the drawings.

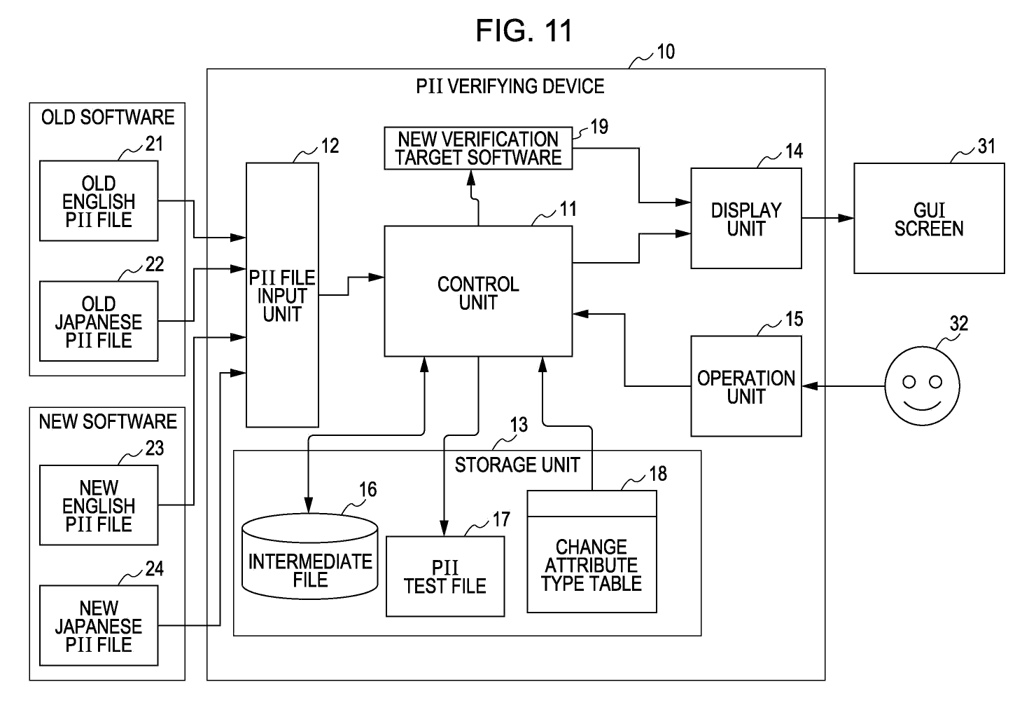

The verification tool program operates on an information processing device (see FIG. 11), which may be typically a computer. The verification tool program is provided as a part of a program development tool, such as a Plug-in of Eclipse (see, a website <URL http://www.eclipse.org> retrieved on Dec. 20, 2006, which is herein incorporated by reference in its entirely). Even in the case that the function cannot be included in a verification target program development environment, the function can be provided, as an independent verification tool program, for PII files of verification target programs written in each language, such as JAVA® or C language.

A user creates a Japanese PII text resource file (simply referred to as a PII file) used for testing using the verification tool program. The user replaces (or overwrites) a normal PII file by this PII test file, and executes the test.

Input items to be specified by the user for the verification tool program are as follows. Meanwhile, a character code, such as “native code to ascii”, for the PII file assumes a state before conversion is performed.
(1) Four new and old versions of Japanese and English directories (folders)
(2) A Japanese TVT file output directory (folder)
(3) A type of “change attribute” regarding which both Japanese and English are displayed on a GUI (as described later, eight types of change attribute can be selected herein)

### Overview of Processing of Verification Tool Program

The verification tool program creates one intermediate file from four kinds of PII files, namely, new and old versions of Japanese and English PII files, supplied as input. The intermediate file may be considered as one database, and a normal relational database may be used as this database. However, herein, a text file, in which one line of text is considered as one data record and the data is separated using “=”, is created to easily perform processing as a Plug-in of Eclipse or the like. A PII file used for translation verification (a PII test file) is ultimately created from this intermediate file. That is, a set of PII files as four kinds of input files and a PII test file as one output file are shown to a user.

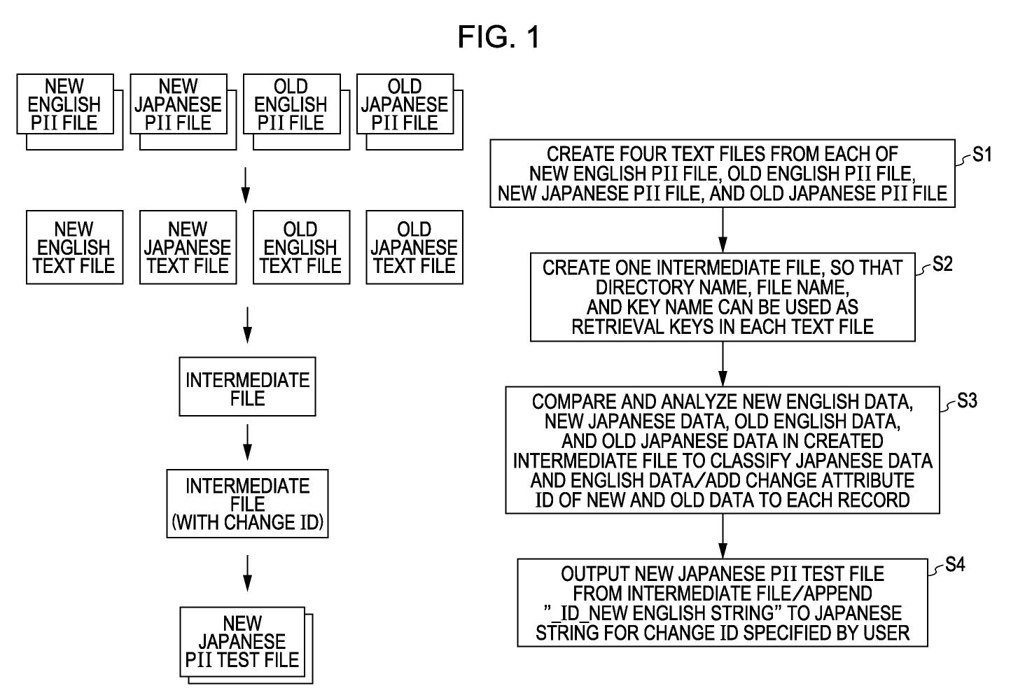

FIG. 1 is a diagram showing an overview of processing of the verification tool program. Acts S1 to S4 in the figure will be sequentially described.

### <ACT S1>

Four text files are created from a set of four kinds of new and old versions of Japanese and English (new English, old English, new Japanese, and old Japanese) PII files, respectively. Hereinafter, a new English version, an old English version, a new Japanese version, and an old Japanese version are abbreviated as “new English”, “old English”, “new Japanese”, and “old Japanese”, respectively.

This text file is constituted by character strings separated with a sign “=”. This is because it is convenient for comparison of characters to use this sign as a separator, since “=” generally follows a key. A text file that uses “=” as a separator is referred to as an “equal separated value” herein (needless to say, the separator is not necessarily “=”, and may be any other sign). Meanwhile, when “=” appears in data, “=” is replaced by a symbol, such as “&equalNls.”.

Hereinafter, description will be mainly given for “CATNls” files, which are PII files of CATIA®, as an example. An equal separated value is a data that one line constitutes one record as shown below.

E7b1=1=2DViewer.CATNls=Title=“2DViewer”

In this example, “E7b1” at the top is an ID of a new version of English file, and represents a meaning of English, version 7 (new version), build b, and PII file number 1 (a serial number for all of the PII files). However, this file ID is not mandatory. In addition, “=” is a separator described before. The following “1” represents a line number in each file. “2DViewer.CATNls” represents a PII file name. “Title” represents a key name, while “2DViewer” represents a new version of English character string.

### <ACT S2>

At the next act, one intermediate file is created from the four text files so that a directory name and a file name of the new version of English file and a key name can be used as retrieval keys. In the above-described example, one line record as shown below can be obtained.

E7b1 = 1 = 2DViewer.CATNls = Title = “2DViewer” =
J7b1 = 1 = “2Dbyua” = E6c1 = 1 = “2DViewer” = J6c1
= 1 = “2DByua”

In this example, the ID of a new version of English file, the line number, the file name, the key name, and the new version of English character string are sequentially concatenated. Then, “J7b1” (an ID of a new version of Japanese file representing Japanese, version 7, build b, and a PII file number 1), a line number, and a new version of Japanese character string follow. Thereafter, similarly, “E6c1” (an ID of an old version of English file), a line number, an old version of English character string, “J6c1” (an ID of an old version of Japanese file), a line number, and an old version of Japanese character string are concatenated.

### <ACT S3>

Then, the new English data, the new Japanese data, the old English data, and the old Japanese data included in the intermediate file created at act S2 are compared and analyzed to classify Japanese data and English data. A change attribute ID (change ID) for changes in new and old versions is added to each record. In the above example, the record will be as follows.

E7b1 = 1 = 2DViewer.CATNls = Title = “2DViewer” =
J7b1 = 1 = “2Dbyua” = E6c1 = 1 = “2DViewer” = J6c1
= 1 = “2DByua” = 0;

“0” at the last is the change ID. Although the above example shows a case of CATIA, the record is represented as shown below in JAVA®. Both representations are substantially the same. Accordingly, the present invention can cope with any program languages since the notation of the record is unrelated to notation of program languages.

E7b1 = 1 = 2DViewer.CATNls = Title = 2DViewer =
J7b1 = 1 = 2Dbyua = E6c1 = 1 = 2DViewer = J6c1 = 1
= 2DByua = 0

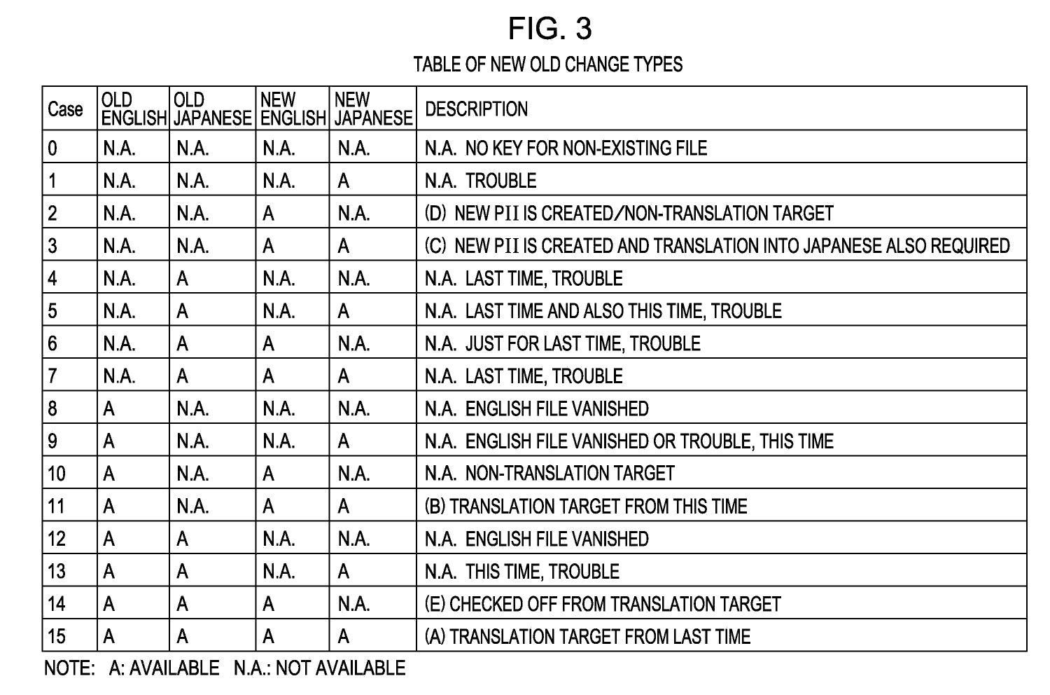

FIG. 2 is a type table that defines types of the change attribute ID. In addition, FIG. 3 is a table in which types of change in new and old versions of English and Japanese files are classified into a total of 2×2×2×2 kinds, i.e., 16 kinds, depending on whether each version of file is available or not. The change attribute ID type table of FIG. 2 further classifies five kinds (those indicated by (A), (B), (C), (D), and (E) in a description column of FIG. 3), which are significant as translation targets, from the table of FIG. 3 and defines the types. For example, (A) in FIG. 3 is further classified into IDs of 1(A) to 3(A) in FIG. 2. Herein, “created” in FIG. 2 means that a file is newly created. In the case of English files, a key is newly created, and a character string is also created at the same time. In the case of Japanese files, “created” means that a PII file is specified as a translation target, and a Japanese translated file is created.

### <ACT S4>

Lastly, a new version of Japanese PII file used for translation verification (a PII test file) is created with reference to the intermediate file processed at act S3. At this time, regarding the change attribute ID specified by a user, “_ID_new version of English character string” is appended to a Japanese character string.

On the basis of the change attribute ID input by the user, this verification tool program outputs one of the followings to a PII file on a line-by-line basis.
New version of Japanese key and Japanese PII character string (e.g., key=fairu no kopi saki)
New version of Japanese key and Japanese PII character string_change ID_English PII character string (e.g., key=fairu no kopi saki_{—}2_Copy file to)

Then, a normal Japanese PII file used at the time of execution of application is replaced with the created Japanese PII test file. In the above-cited example enclosed by parentheses, a separator for the change ID is set as “_”. Here, the separator is a delimiter character used for displaying, and may be a character other than the foregoing “separator”. In addition, as shown in the table of FIG. 2, the change ID 2 means that “old version of Japanese is modified (no changes in English)”.

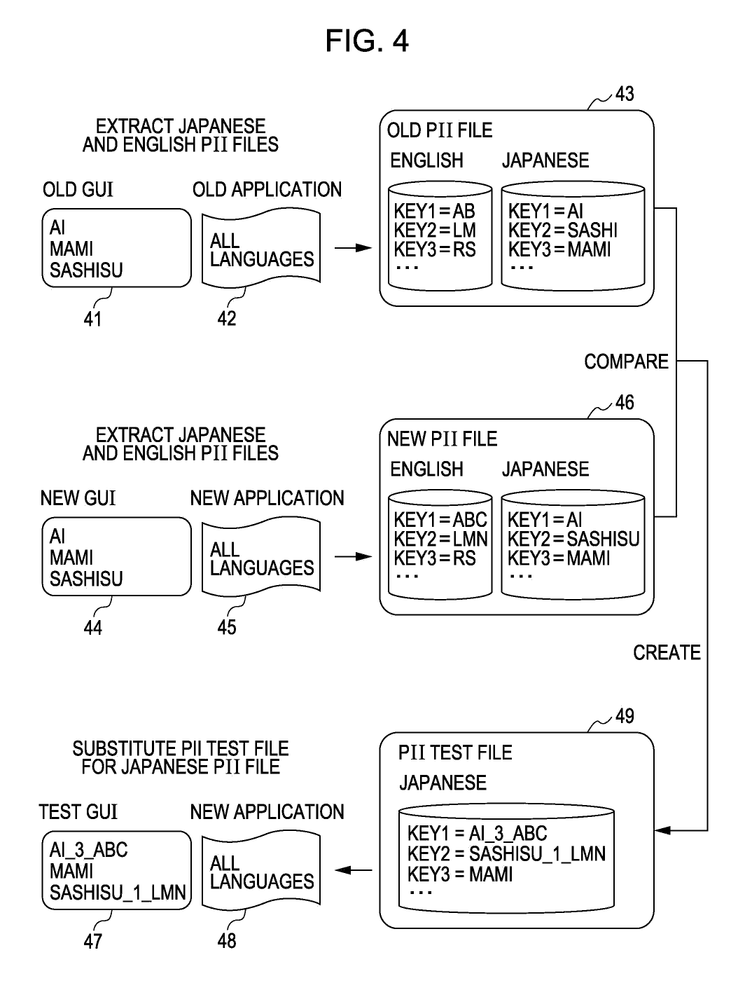

FIG. 4 shows a flow of creating a new version of Japanese PII file used for translation verification. In this figure, old versions of English and Japanese PII files 43 are extracted from an old version of GUI 41 and an old version of application (software) 42 (multilingual-compatible). In addition, new versions of English and Japanese PII files 46 are extracted from a new version of GUI 44 and a new version of application (software) 45 (multilingual-compatible). Those PII files are then compared. On the basis of the comparison result, a Japanese PII test file 49 is created. By means of the test file, a test GUI 47 is displayed using a new version of application 48. It should be noted that the order of displayed objects on a GUI do not related to that of keys.

Although the above example assumes the case of CATIA, in the case of JAVA®, conversion of a character code (such as, native code to ascii) is performed when the PII files are extracted from the application. Conversely, the same applies when the PII files are incorporated into the application.

### SECOND EMBODIMENT

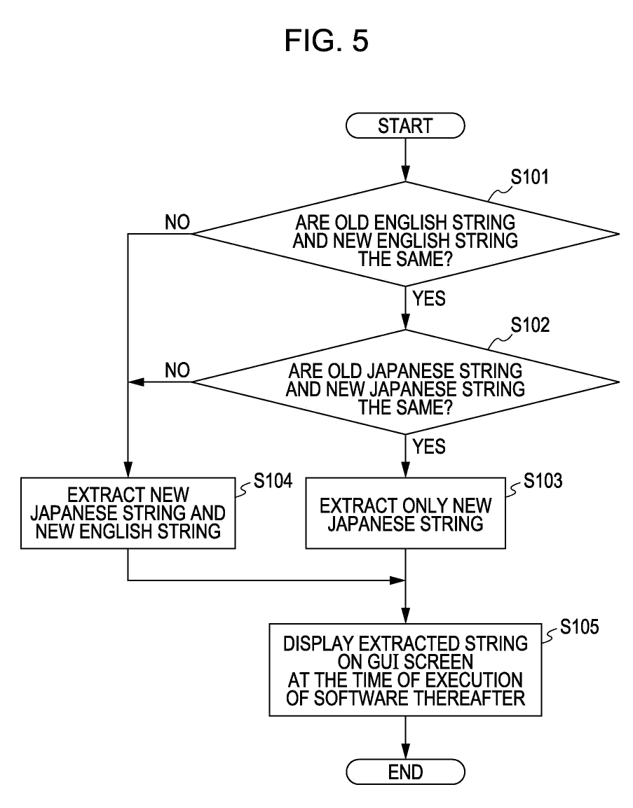

FIG. 5 shows alternative acts of the above described acts S3 to S4. That is, this figure shows a simpler method that does not use the change attribute ID. Firstly, at acts S101 and S102, it is determined whether or not an old version of English character string and a new version of English character string are the same and whether or not an old version of Japanese character string and a new version of Japanese character string are the same. If both decisions at acts S101 and S102 are YES, only the new version of Japanese character string is extracted (act S103). If one of the decisions at acts S101 and S102 is NO, the new version of Japanese character string and the new version of English character string are extracted (act S104). Then, these extracted character strings are displayed on a GUI screen at the time of execution of software thereafter (act S105). More specifically, act S105 can be realized by creating a PII test file using these extracted character strings, and by the software replacing the PII file used at the time of normal execution with the created PII test file. By configuring in this way, there is no need to prompt a user to specify the change attribute ID. However, in this method, display of a translated character string cannot be changed on a GUI depending on the types of change.

### Verification Tool Program

Implementation of a program will be described below for a case of using a CATNls file of CATIA as an example. Herein, a method for easily processing data with a small or simple program not using an expensive commercial database is shown. In particular, this method is convenient for the JAVA® environment and for incorporating the program into Eclipse or the like as a Plug-in. Needless to say, a commercial database or the like may be utilized.

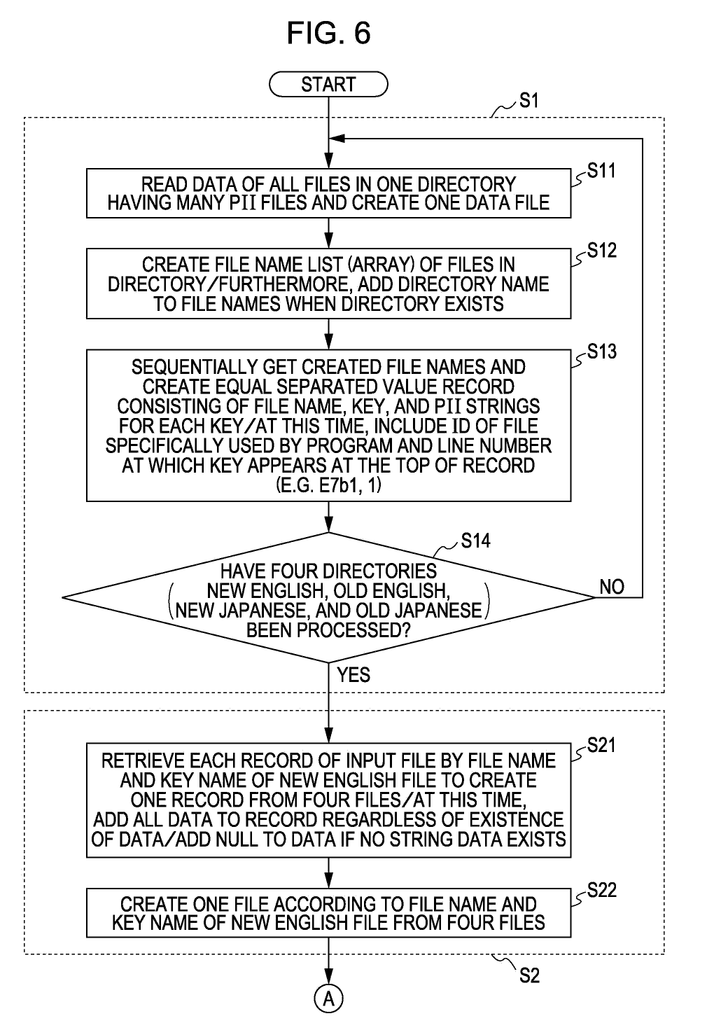

Now, act S1 of FIG. 1 will be described in detail. Acts S11 to S14 of a flowchart of FIG. 6 show details of act S1.

Firstly, at act S11, data of all of the files contained in one directory having a plurality of PII files is read out, and one data file is created.

Next, at act S12, a file name list (array) of the files contained in the directory is created. Furthermore, when there is a directory, the directory name is also included in the file name.

Then, at act S13, a file name is sequentially extracted from the list created at act S12 to create an equal separated value record, constituted by a file name, a key, and a PII character string, for each key. At this time, to make file management easier, a file ID and a line number at which the key appears are also included at the top of the record (e.g., the file ID and the line number are like E7b1, 1).

Processing of the above-described acts S11 to S13 is repeated until the processing completes for four directories, namely, the new English directory, the old English directory, the new Japanese directory, and the old Japanese directory (act S14).

Although approximately 8000 PII files exist in CATIA, the PII files are collected in one folder in practice. In the case of JAVA®, the PII files are sorted to tree-structure folders. When files are dividedly contained in folders, a directory name is attached in front of a file name, which is used as the file name.

As an example, first six lines of 2DViewer.CATNls file of CATIA are shown below. Generally, the file includes comments or the like.

Title = “2DViewer”;
Visibility.Title = “Visibility”;
Visibility.Help = “The “Visibility” property, of
type “boolean”.”;
AsyncRefreshable.Title = “AsyncRefreshable”;
AsyncRefreshable.Help = “The “AsyncRefreshable”
property, of type “boolean”.”;
URL.Title = “URL”;

A text file is created while assigning file IDs to the above-described files in the following manner. That is, the above-described approximately 8000 PII files are integrated into one file. An example shown below illustrates first several lines of this file. From the left on each line, a file ID (E7b1) of this text file, a line number, a file name, a key, and a character string are shown. The file is an equal separated value. However, in the present invention, the ID is not necessarily assigned.

E7b1 = 1 = 2DViewer.CATNls = Title =
“2DViewer”
E7b1 = 2 = 2DViewer.CATNls = Visibility.Title =
“Visibility”
E7b1 = 3 = 2DViewer.CATNls = Visibility.Help = “The
“Visibility” property, of type “boolean”.”
E7b1 = 4 = 2DViewer.CATNls = AsyncRefreshable.Title
= “AsyncRefreshable”
E7b1 = 5 = 2DViewer.CATNls = AsyncRefreshable.Help
= “The “AsyncRefreshable” property, of type
“boolean”.”
E7b1 = 6 = 2DViewer.CATNls = URL.Title = “URL”

Four such text files are created for the PII file contained in each of the new and old English and Japanese directories.

Acts S21 to S22 of FIG. 6 show details of act S2 of FIG. 1.
Firstly, at act S21, each record of an input file is retrieved using the file name of the new version of English (new English) file and the key name, and one record is created from four files. At this time, data is added to the record regardless of existence or absence of the data. If there is no character string data, NULL is added to data. This is because Japanese data may not exist although English data exists in the record.

Next, at act S22, one file according to the name of the new version of English file and the key name is created from the four files.

At the above-described acts, the following data, in which the new English, new Japanese, old English, and old Japanese records are concatenated, is created as an example. Then, the data is used as one intermediate file that employs the new version of English key as the retrieval key.

E7b1 = 1 = 2DViewer.CATNls = Title = “2DViewer” =
J7b1 = 1 = “2Dbyua” = E6c1 = 1 = “2DViewer” = J6c1
= 1 = “2Dbyua”
E7b1 = 2 = 2DViewer.CATNls = Visibility.Title =
“Visibility” = J7b1 = 2 = “Hyouji/Hihyouji” = E6c1
= 2 “Visibility” = J6c1 = 2 = “Hyouji/Hihyouji”
E7b1 = 3 = 2DViewer.CATNls = Visibility.Help = “The
“Visibility” property, of type “boolean”.” = J7b1 =
3 = “Taipu “buru” no “hyouji/hihyouji” puropathi
desu.” = E6c1 = 3 = “The “Visibility” property, of
type “boolean”.” = J6c1 = 3 = “Taipu “buru” no
“hyouji/hihyouji” puropathi desu.”
E7b1= 4 = 2DViewer.CATNls = AsyncRefreshable.Title
= “AsyncRefreshable” = J7b1 = 4 = “Hidouki
rihuresshu kanou” = E6c1 = 4 = “AsyncRefreshable” =
J6c1 = 4 = “Hidouki rihureshu kanou”
E7b1 = 5 = 2DViewer.CATNls = AsyncRefreshable.Help
= “The “AsyncRefreshable” property, of type
“boolean”.” = J7b1 = 5 = “Taipu “buru” no “hidouki
rihuresshu kanou” puropathi desu.” = E6c1 = 5 =
“The “AsyncRefreshable” property, of type
“boolean”.” = J6c1 = 5 = “Taipu “buru” no “hidouki
rihuresshu kanou” puropathi desu.”
E7b1 = 6 = 2DViewer.CATNls = URL.Title = “URL” =
J7b1 = 6 = “URL” = E6c1 = 6 = “URL” = J6c1 = 6 =
“URL”

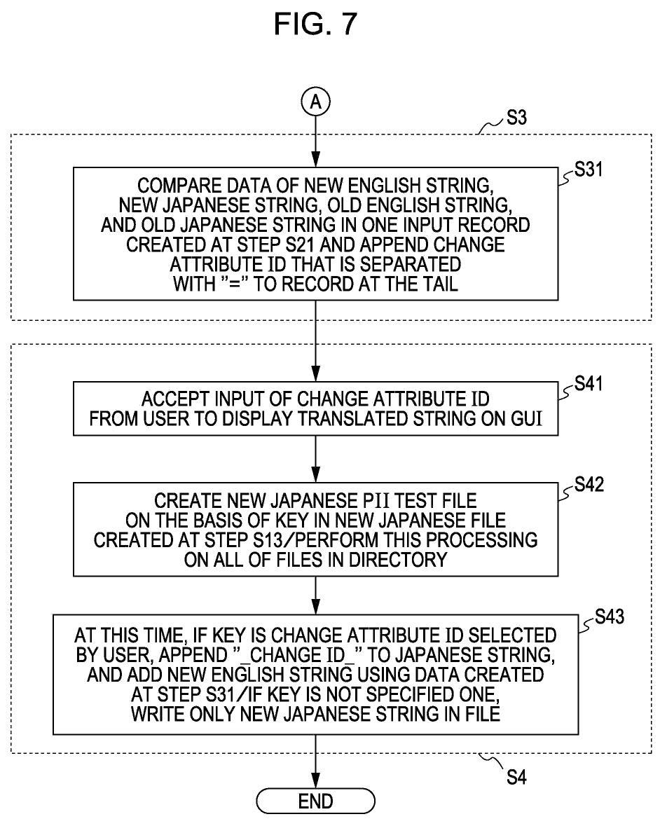

Act S31 of the flowchart of FIG. 7 shows details of act S3 of FIG. 1. The data contained in the record is sequentially arranged in the order of
1. ID of the new version of English file
2. line number in the new version of English file
3. file name
4. key name
5. new version of English character string
6. ID of the new version of Japanese file
7. line number in the new version of Japanese file
8. new version of Japanese character string
9. ID of the old version of English file
10. line number in the old version of English file
11. old version of English character string
12. ID of the old version of Japanese file
13. line number in the old version of Japanese file
14. old version of Japanese character string
15. change attribute ID for new and old versions of English and Japanese.

In such a case, the new version of English character string, the new version of Japanese character string, the old version of English character string, and the old version of Japanese character string are at the 5th, the 8th, the 11th, and the 14th data of one input record. Those character strings are compared and the equal (“=”)-separated change attribute ID for the old and new versions of English and Japanese is added to the end of the record.

At the above act, the change attribute ID (the change ID) is added to the above-described data. An example result of this addition is shown below. As described before, the change ID is divided into eight kinds (1-8) as shown in the table of FIG. 2. To be precise, since a change ID other than the eight kinds is set as “others”, namely, “0”, the change ID is categorized into a total of nine kinds. In this example, all of the change ID set equal to 0. The “others” mean that no changes exist in new and old versions, or that the change is meaningless. A result of processing at the above-described act S31 is as follows.

E7b1 = 1 = 2DViewer.CATNls = Title = “2DViewer” =
J7b1 = 1 = “2Dbyua” = E6c1 = 1 = “2DViewer” = J6c1
= 1 = “2Dbyua” = 0
E7b1 = 2 = 2DViewer.CATNls = Visibility.Title =
“Visibility” = J7b1 = 2 = “Hyouji/Hihyouji” = E6c1
= 2 “Visibility” = J6c1 = 2 = “Hyouji/Hihyouji” =
0
E7b1 = 3 = 2DViewer.CATNls = Visibility.Help =
“The “Visibility” property, of type “boolean”.” =
J7b1 = 3 = “Taipu “buru” no “hyouji/hihyouji”
puropathi desu.” = E6c1 = 3 = “The “Visibility”
property, of type “boolean”.” = J6c1 = 3 = “Taipu
“buru” no “hyouji/hihyouji” puropathi desu.” = 0
E7b1 = 4 = 2DViewer.CATNls =
AsyncRefreshable.Title = “AsyncRefreshable” = J7b1
= 4 = “Hidouki rihuresshu kanou” = E6c1 = 4 =
“AsyncRefreshable” = J6c1 = 4 = “hidouki
rihuresshu kanou” = 0
E7b1 = 5 = 2DViewer.CATNls = AsyncRefreshable.Help
= “The “AsyncRefreshable” property, of type
“boolean”.” = J7b1 = 5 = “Taipu “buru” no “hidouki
rihuresshu kanou” puropathi desu.” = E6c1 = 5 =
“The “AsyncRefreshable” property, of type
“boolean”.” = J6c1 = 5 = “Taipu “buru” no “hidouki
rihuresshu kanou” puropathi desu.” = 0
E7b1 = 6 = 2DViewer.CATNls = URL.Title = “URL” =
J7b1 = 6 = “URL” = E6c1 = 6 = “URL” = J6c1 = 6 =
“URL” = 0

In addition, an example in which the change ID other than “0” is attached as a result of the processing at act S31 is shown in the following. Here, the file ID “E7b1801” represents English version 7. Similarly, “J7b1175” represents Japanese version 7.

E7b1801 = 75 = CATDetailDittoCmd.CANTls =
CATDetailDittoCmn.PushBFlipY.Check.ShortHelp =
“Flips the component around the X axis” = J7b1175 =
75 = “Kouseiyouso wo Xjiku no mawarini hanten
shimasu” ====== 1
E7b1801 = 78 = CATDetailDittoCmd.CATNls =
CATDetailDittoCmd.LinkPropertyAgentResource.LinkWith.ShortHelp
= “Link With Detail” = J7b1175 = 78 =
“dhiteru tuki rinku” ====== 1
E7b1801 = 79 = CATDetailDittoCmd.CANTNls =
CATDetailDittoCmd.LinkPropertyAgentResource.LinkWith.LongHelp
= “Creates a 2D Component Instance
having Link With Detail in detail sheet” = J7b1175
= 79 = “dhiteru shiito ni dhiteru tuki rinku no aru
2D Kouseiyouso insutansu wo sakusei shimasu” ======
1

Acts S41 to S43 of the flowchart of FIG. 7 show details of act S4 of FIG. 1.

Firstly, at act S41, input of the change attribute ID (the change ID) for the new and old versions of English and Japanese selected by a user is received to display the translated character string on a GUI. Next, at act S42, a new version of Japanese PII test file is created on the basis of keys existing in the new version of Japanese file created at act S13. This processing is performed on all of the files in the directory. At this time, at act S43, in the case that the key satisfies the change attribute ID for the new and old versions of English and Japanese selected by the user, “_change ID for new and old versions of English and Japanese_” is appended to the Japanese character string. The new version of English character string is also appended using the data created at act S31. If the key is not the specified one, only the new version of Japanese character string is written in the file.

In this way, the Japanese PII file for translation verification is created at act S4 from the new version of Japanese text file created at act S1. A location where the file is created may be a given location specified by the user of the tool program. At this time, regarding those for which the user specifies the change attribute ID, the ID and the English character string are appended to the Japanese character string. Regarding those other than the specified ID, there is only the Japanese character string and neither the ID nor the English character string is added. In addition, if all types of change ID are selected, the Japanese character string, the change ID, and the English character sting are displayed for all of the PII character string. Generally, since change ID=others “0” is not selected, it is possible display the change ID and the English character string regarding only those involving a change that the user wants to see.

A final output of act S4 is a Japanese PII test file. However, the file does not include information unnecessary for the testing, such as comments. Regarding those for which the user selected the change ID, the change ID and the new version of English is attached to the Japanese. In the following, a Japanese PII test file obtained when only one change ID is selected is shown as an example. In this example, data in a file of 2DViewer.CATNls is ultimately constituted by only Japanese.

Title = “2Dbyua”;
Visibility.Title = “Hyouji/Hihyouji”;
Visibility.Help = “Taipu “buru” no
“hyouji/hihyouji” puropathi desu.”;
AsyncRefreshable.Title = “Hidouki refuresshu
kanou”;
AsyncRefreshable.Help = “Taipu “buru” no “hidouki
rihuresshu kanou” puropathi desu.”;
URL.Title = “URL”;

In addition, data in a file of CATDetailDittoCmd.CATNls, which is another CATIA PII file, is as follows in the Japanese PII test file.

CATDetailDittoCmd.PushBFlipY.Check.ShortHelp =
“Kouseiyouso wo Xjiku no mawarini hanten
shimasu_1_Flips the component around the X axis”;
CatDetailDittoCmd.LinkPropertyAgentResource.LinkWith.ShortHelp =
“Dhiteru tuki rinku_1_Link With
Detail”;
CATDetailDittoCmd.LinkPropertyAgentResource.LinkWith.LongHelp =
“Dhiteru shiito ni dhiteru tuki rinku
no aru 2D Kouseiyouso insutansu wo sakusei
shimasu_1_Creates a 2D Component Instance having
Link With Detail in detail sheet”;

In this file, display of the change ID and the English character string on a screen is as follows.

Dhiteru tuki rinku_{—}1_Link With Detail

By this, since an English character string for this “dhiteru tuki rinku” is created, in association with which, it is known that the Japanese translation is provided in this version upgrade. Thus, users can pay attention. The users determine that “Dhiteru ni rinku” is the proper translation from the flow of the actual screen, and the translation has to be modified on the TVT. Of course, if options for displaying the IDs and the English character strings are provided, it is possible to display only the IDs or only English character strings.

### SCREEN EXAMPLE

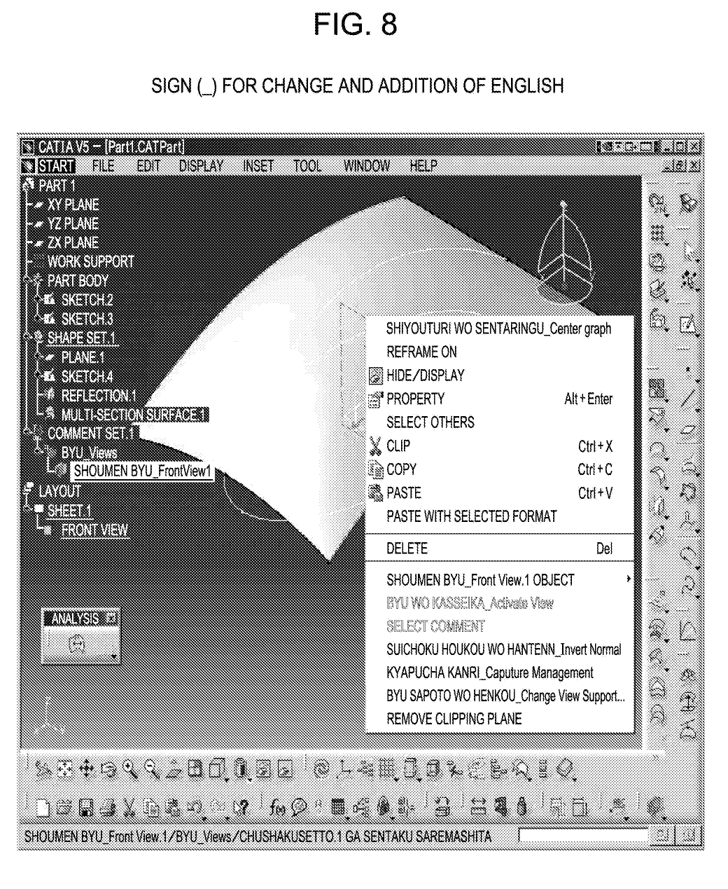

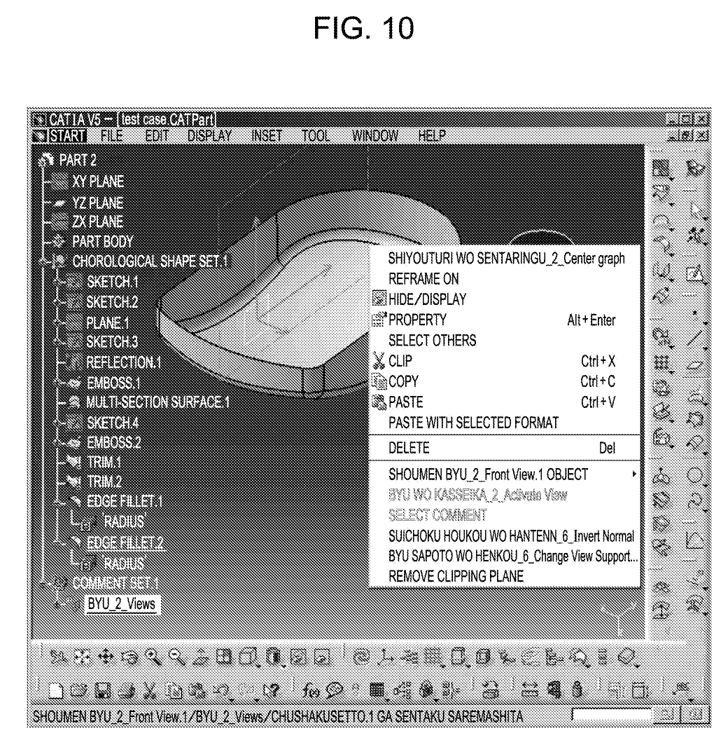

This verification tool program appends English character strings to Japanese character strings involving six types of change out of the eight types of change defined in the table of FIG. 2, and currently uses the character strings in the TVT test. Accordingly, numerals for the ID are omitted and the record is simplified only with “_”. The target software is CATIA. Although an example screen slightly differs from the above-described implementation example of the verification tool program, FIG. 8 shows, as an example showing actual appearance, a capture image when a CATIA PII file is replaced by a PII file created by the verification tool program. In addition, FIG. 10 shows a capture image displaying change attribute IDs when a CATIA PII file is replaced by a PII file created by the verification tool program. In the example of FIG. 10, a change attribute ID and a new version of English character string are displayed at the tail of a new version of Japanese character string. Regarding the character strings to be displayed here, only those having the change attribute ID specified by the user may be displayed.

For example, “SHOUMEN BYU_Front View.1/BYU-Views/CHUSHAKUSETTO.1 GA SENTAKU SAREMASHITA” on the last line of FIG. 8, four PII character strings of “SHOUMEN BYU”, “BYU”, “CHUSHAKUSETTO”, and “SENTAKU SAREMASITA” are combined. “/” and “1.” are the character strings embedded in CATIA program itself and are not directly related to the PII file. In addition, since each of “SHOUMEN BYU” and “BYU” has a change attribute ID, it is known that attention is needed in the translation verification. Conversely, “CHUSHAKUSETTO” and “SENTAKU SAREMASHITA” are not attached with English character strings, which means that there is no change from the previous version.

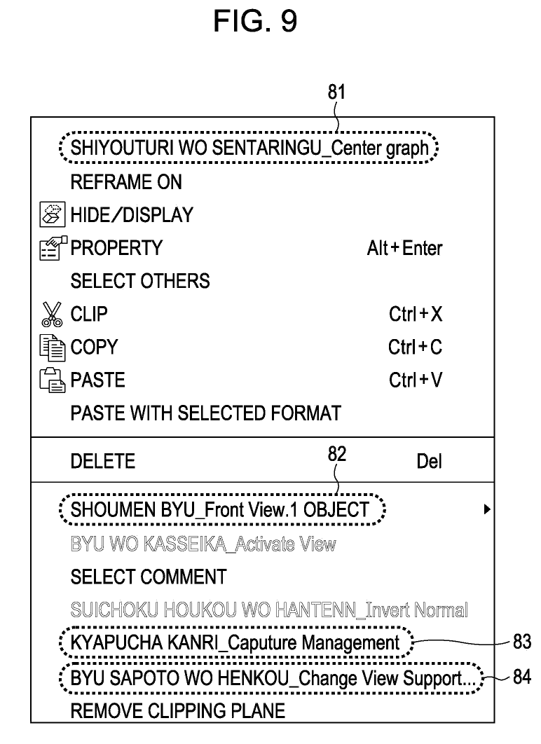

FIG. 9 is an enlarged view of a pop-up menu of FIG. 8. In parts 81, 82, 83, and 84 enclosed by a dotted line, a Japanese character string and an English character string are shown in pairs with “_” according to the techniques of the present invention. Displaying of the change ID is also omitted here.

FIG. 11 is a diagram showing functional blocks of an information processing device (hereinafter, referred to as a PII verifying device 10) according to an embodiment of the present invention. The device may be a common computer, such as a personal computer. The device includes a control unit 11 (a CPU) for performing control of the entire device, a PII file input unit 12 for receiving input of PII files, a storage unit 13 (a RAM, a ROM, a HDD, an optical disk, a flexible disk, a tape, or the like) for storing various data, a display unit 14 (a CRT, a liquid crystal display, or the like) for providing interfaces with a user 32, and an operation unit 15 (a keyboard, a mouse, or the like). The PII files to be input are four kinds of file, namely, old version of English PII file 21, old version of Japanese PII file 22, new version of English PII file 23, and new version of Japanese PII file 24. In addition, although not shown in particular in the figure, the device may include a communication unit for performing communication with external devices, and an audio interface unit (a microphone, a speaker, or the like). However, such a configuration is illustrative only, and other configurations can be employed as long as they are functionally equivalent.

The storage unit 13 stores one text file of the above-described four kinds of PII files, an intermediate file 16, and a change attribute type table 18 that defines types of change attribute of new and old PII files. Furthermore, the storage unit 13 stores a PII test file 17 created as an output of this device. In practice, since there is a plurality of PII files to be input, text files are created for each of the new and old Japanese and English PII files, and then are integrated into one intermediate file 16.

The control unit 11 activates new version of verification target software 19 and displays a GUI screen 31 including the translated character strings to the user 32. At this time, the user 32 can specify the change attribute ID regarding the character strings that the user want to display on the GUI screen through the operation unit 15. The device has means for realizing each act of FIG. 1 by implementing the above-described verification tool program. Since details of each means are obvious from the foregoing description about the verification tool program, the description is omitted here.

Although embodiments of the present invention have been described above, the present invention is not limited to the above-described embodiments. In addition, advantages described in the embodiments of the present invention are only the most preferable advantages resulting from the present invention, and the advantages of the present invention are not limited to those described in the embodiments and the examples of the present invention.

We claim:

1. A method for verifying a character string translated from a first language into a second language in a resource file of verification target multilingual software using a tool program for verification, the method comprising:
the tool program creating four text files, each corresponding to old and new versions in the first language and in the second language, from a set of old and new versions of PII (program integrated information) files in the first language and old and new versions of PII files in the second language resulting from version upgrade of the verification target software;
the tool program extracting a character string to be translated, a key name serving as an identifier of the character string, a directory name and a file name of the PII file in the first language that contains the character string from each of the four text files;
the tool program creating an intermediate file containing a plurality of records in which the extracted key name, the directory name, and the file name are attached to the character string as retrieval keys; and
the tool program creating a PII file for translation verification in the second language from each record in the intermediate file.

2. The method according to claim 1, further comprising:
the tool program comparing old and new versions of character strings in the first language and old and new versions of character strings in the second language included in each record of the intermediate file with reference to the retrieval keys;
the tool program extracting the new version of the character string in the second language as a character string for displaying if the old and new versions of the character strings in the first language are the same and the old and new versions of the character strings in the second language are the same; and
the tool program extracting the new version of the character string in the first language and the new version of the character string in the second language as the character strings for displaying otherwise.

3. The method according to claim 1, further comprising:
the tool program comparing old and new versions of character strings in the first language and old and new versions of character strings in the second language included in each record of the intermediate file with reference to the retrieval keys; and
the tool program attaching a change attribute ID, representing a type of change in the character strings obtained based on the comparison result, to each record of the intermediate file.

4. The method according to claim 2, further comprising:
displaying the character string for displaying on a graphical user interface (GUI) screen displayed by the verification target software at the time of execution.

5. The method according to claim 3, further comprising:
displaying the change attribute ID and the compared character strings on a graphical user interface (GUI) screen displayed by the verification target software at the time of execution.

6. The method according to claim 5, wherein, at the act of displaying, a user of the tool program is prompted to specify the change attribute ID to be displayed.

7. The method according to claim 5, wherein, at the act of displaying, both the character string in the first language and the character string in the second language are displayed on the graphical user interface (GUI) screen if the change attribute ID indicates that each of the new and old versions of character strings in the first language and the second language are compared and there is a change in at least one of those character strings.

8. The method according to claim 3, wherein the change attribute ID is classified on the basis of cases that each of the old version of PII files in the first language and in the second language is “available” and “not available”, and cases that each of the new version of PII files in the first language and the second language is “available and the same”, “available and updated”, “available and created”, “not available and the same”, and “not available and vanished”.

9. The method according to claim 1, wherein a separator is used in the records of the intermediate file to separately identify the key name, the directory name, the file name, and the character string.

10. The method according to claim 9, wherein the separator is “=”.

11. The method according to claim 9, wherein the record is constituted by a line of text.

12. A computer program product for allowing a computer to execute a method for verifying a character string translated from a first language into a second language in a resource file of verification target multilingual software using a tool program for verification, the method comprising:
causing the computer to create four text files, each corresponding to old and new versions in the first language and in the second language, from a set of old and new versions of PII files in the first language and old and new versions of PII files in the second language resulting from version upgrade of the verification target software;
causing the computer to extract a character string to be translated, a key name serving as an identifier of the character string, a directory name and a file name of the PII file in the first language that contains the character string from each of the four text files;
causing the computer to create an intermediate file containing a plurality of records in which the extracted key name, the directory name, and the file name are attached to the character string as retrieval keys; and
causing the computer to create a PII file for translation verification in the second language from each record in the intermediate file.

13. The computer program product according to claim 12, the method further comprising:
causing the computer to compare old and new versions of character strings in the first language and old and new versions of character strings in the second language included in each record of the intermediate file with reference to the retrieval keys; and
causing the computer to extract the new version of the character string in the second language as a character string for displaying if the old and new versions of the character strings in the first language are the same and the old and new versions of the character strings in the second language are the same; and
causing the computer to extract the new version of the character string in the first language and the new version of the character string in the second language as the character strings for displaying otherwise.

14. The computer program product according to claim 12, the method further comprising:
causing the computer to compare old and new versions of character strings in the first language and old and new versions of character strings in the second language included in each record of the intermediate file with reference to the retrieval keys; and
causing the computer to attach a change attribute ID, representing a type of change in the character strings obtained based on the comparison result, to each record of the intermediate file.

15. A device for verifying a character string translated from a first language into a second language in a resource file of verification target multilingual software, the device comprising:
a control unit; and
a PII file input unit for receiving, as input, a set of old and new versions of PII files in the first language and old and new versions of PII files in the second language resulting from version upgrade of the verification target software, wherein
wherein the control unit is operable to:
create four text files, each corresponding to old and new versions in the first language and in the second language, from the set of the old and new versions of PII files in the first language and the old and new versions of PII files in the second language, input from the PII file input unit,
extract a character string to be translated, a key name serving as an identifier of the character string, a directory name and a file name of the PII file in the first language that contains the character string from each of the four text files,
create an intermediate file containing a plurality of records in which the extracted key name, the directory name, and the file name are attached to the character string as retrieval keys, and
create a PII file for translation verification in the second language from each record in the intermediate file.

16. The device according to claim 15, wherein the control unit further is further operable to:
compare old and new versions of character strings in the first language and old and new versions of character strings in the second language included in each record of the intermediate file with reference to the retrieval keys, and
extract the new version of the character string in the second language as a character string for displaying if the old and new versions of the character strings in the first language are the same and the old and new versions of the character strings in the second language are the same, and
extract the new version of the character string in the first language and the new version of the character string in the second language as the character strings for displaying otherwise.

17. The device according to claim 15, wherein the control unit is further operable to:
compare old and new versions of character strings in the first language and old and new versions of character strings in the second language included in each record of the intermediate file with reference to the retrieval keys, and
attach a change attribute ID, representing a type of change in the character strings obtained based on the comparison result, to each record of the intermediate file.

18. The device according to claim 16, further comprising:
a display unit for displaying the character string for displaying on a graphical user interface (GUI) screen displayed by the verification target software at the time of execution.

19. The device according to claim 17, further comprising:
a display unit for displaying the change attribute ID and the compared character strings on a graphical user interface (GUI) screen displayed by the verification target software at the time of execution.
